(19) United States
(12) Patent Application Publication
(10) Pub. No.: US 2004/0161581 A1
(43) Pub. Date: Aug. 19, 2004

(54) Floor mat for automobile

(75) Inventors: Kenji Kurabe, Hyogo (JP); Tadashi Takase, Nara (JP)

Correspondence Address: Norris, McLaughlin & Marcus P.A., 30th Floor, 220 East 42nd Street, New York, NY, 10017, US

(73) Assignee: SAHAKIT WISARN CO., LTD., Bangkok (TH)

(21) Appl. No.: 10/366,826

(22) Filed: Feb. 14, 2003

(51) Int. Cl. B32B 3/02

(52) U.S. Cl. 428/88; 428/137; 428/158

(57) ABSTRACT

An automobile mat which overcomes the border which divides the sound absorption or interruption function of the floor mat, wherein the mat absorbs or interrupts sound effectively and reduces the noise in the interior of the automobile. The mat comprises a backing cloth having an upper and lower face; a pile layer formed on said upper face of the backing cloth; a felt layer adhered to the lower face of the backing cloth and a top face of a foam latex layer; and the foam latex layer having the top and a bottom face adhered to the bottom face of the felt layer.

### BACKGROUND OF THE INVENTION

The present invention is for a floor mat to be laid inside an automobile in order to reduce the level of external sound and/or improve sound absorption. The floor mat comprises a pile layer formed on an upper face of a backing cloth, a felt layer adhered to a lower face of the backing cloth and the top face of a foam latex layer, and the foam latex layer having a top and bottom face adhered to the bottom face of the felt layer.

The more widely used floor mats have the pile yarn tufted thickly from the back side of the backing cloth, wherein the pile layer is formed at a fixed height on the upper face of the backing cloth. The floor mats are generally constructed of a rubber sheet layer formed on the back face of the backing cloth and many nibs or projections which are planted on the back face of the rubber sheet when the floor mats are finished.

In most cases, the floor mat is a secondary floor mat where the primary carpet consists of a fiber material having the proper thickness being fixedly laid on the floor board of the automobile body. The nibs, which are planted on the rubber sheet of the floor mat, attach themselves to the primary carpet to prevent slippage.

The primary carpet interrupts the noise from the floor board side (ground side) and the floor mat, by absorbing the sound, reduces the interior noise of the automobile.

In the construction of the present floor mat structure, one factor to consider regarding reduction of noise from the floor board side and the interior of the automobile is the rubber sheet layer forming the floor mat. The rubber sheet layer forms a border which divides the sound absorption or sound interruption function. Other factors to consider include, but are not exclusive of, the thickness of the floor mat, pile layer, selection of material, and the weaving method of backing cloth.

An object of the present invention is to overcome the limitations of the rubber sheet layer which divides the sound absorption or interruption functions of the floor mat, wherein a floor mat is disclosed which displays the sound absorption or interruption function and reduces the amount of noise in the interior of the automobile.

### SUMMARY OF THE INVENTION

The present invention provides for an automobile mat comprising:

a) a backing cloth having an upper and lower face;

b) a pile layer formed on said upper face of the backing cloth;

c) a felt layer adhered to the lower face of the backing cloth and a top face of a foam latex layer; and

d) the foam latex layer having the top and a bottom face adhered to a bottom face of the felt layer.

Another embodiment comprises the automobile mat comprising a plurality of holes passing through the felt layer and the backing cloth.

Another embodiment comprises a waterproof film formed on the bottom face of the foam latex layer.

### BRIEF DESCRIPTION OF THE DRAWINGS

FIG. 1 is a cross section of the floor mat showing the layers.

FIG. 2 is a cross section of one embodiment of the floor mat showing each layer.

FIG. 3 is a graph comparing the sound absorption rate between a test piece of the present invention and a test piece of an old floor mat.

### DETAILED DESCRIPTION OF THE INVENTION

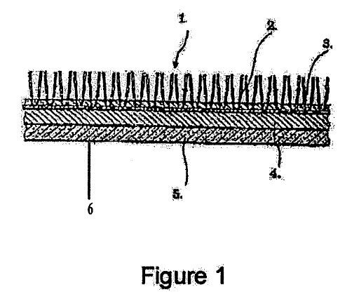

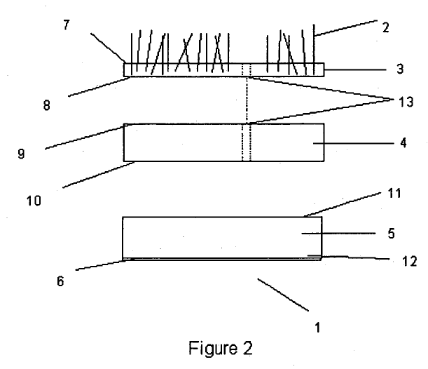

FIGS. 1 and 2 shows an automobile mat (1) comprising a backing cloth (3) having an upper and lower face (7,8), a pile layer (2) formed on the upper face (7) of the backing cloth (3), a felt layer (4) adhered to the lower face (8) of the backing cloth (3) and a top face (11) of the foam latex layer (5), and a foam latex layer having a top and bottom face adhered to a bottom face (10) of the felt layer (4).

The pile yarn used to form the pile layer (2) formed on the upper face (7) of the backing cloth (3) is tufted from the lower face (8) of the backing cloth (3). The pile layer (2) is stabilized by an anchor coating process by a latex compound of the yarn to the lower face (8) of the backing cloth (3).

It is preferable to use a polyester hollow fiber felt as the felt layer (4) to be formed at the lower face (8) of the backing cloth (3). The polyester hollow fiber felt has a porous type sound absorption feature which changes high frequency sound energy to heat energy by friction with the surrounding wall inside the felt and the vibrations of the small fiber. Because the polyester hollow fiber felt is a hollow fiber, the surface area of fiber per unit weight and the energy exchange are substantial.

For the formation of the felt layer (4), a chloroprene rubber adhesive is initially lightly spread to the overall lower face (8) of the backing cloth (3). The solvent is then removed in a dryer to form an adhesive thin film on the lower face (8) of the backing cloth (3). Next, the chloroprene rubber adhesive is spread lightly to both the face of the adhesive thin film and the upper face (9) of the felt layer (4). The solvent is removed in a dryer, and the adhesive is pressed with a press roller. The felt layer is then adhered to the lower face (8) of the backing cloth (3).

The initial preparation of the adhesive thin film improves the adhesiveness with the felt layer, and also improves the film type sound absorption effect and the waterproof effect. As adhesive is lightly-spread on the upper face of hollow fiber felt, adhesiveness on hollow fiber felt is dispersed in dots, so the vibration of the small fiber inside the hollow fiber felt cannot be interrupted.

When the felt layer (4) is formed on the lower face (8) of the backing cloth (3), holes (13) can be made by turning the felt layer (4) upward and making small holes from the felt layer (4) to the backing cloth (3). The holes are 2 mm in diameter and spaced apart at a distance of about 5 mm. By making many holes (13) from the felt layer (4) to the backing cloth (3), resistance to air passage is reduced and sound can more easily pass from the pile layer side to the foam latex layer, wherein the sound absorption effect is improved.

If the holes are too big or too many, the waterproof effect will be reduced as will the strength of the backing cloth and the felt-layer. If there are too few holes, there will be substantial air resistance such that it will be difficult for sound to pass through. The net effect is a reduction in sound absorption.

A natural rubber group foam rubber latex sheet is preferably used as the foam latex layer (5). The natural rubber group foam latex sheet has foamed 4 times or so. The sheet displays a sound absorption function having a film vibration type feature. For the formation of the foam latex layer, a chloroprene rubber group adhesive is spread lightly on the lower face (10) of the felt layer (4) and the top face (11) of the foam latex sheet (5). The solvent is removed in a dryer and the adhesive is then pressed using a press roller. The felt layer (4) is then adhered to the foam latex sheet (5). The adhesive is spread lightly as dots on the felt layer. Also, as it is spread on the foam latex sheet lightly so that bubbles may not be destroyed, it will neither disturb the vibration of the small fiber inside the hollow fiber felt nor change the ventilation. A suitable adhesive is used for joining the lower face of the backing cloth and the felt layer and for joining the felt layer and the foam latex layer.

At the time of sheet processing of the corresponding latex layer, if the foaming is controlled a waterproof thin film is formed on the back of the foam latex layer, wherein the waterproof thin film displays sound absorption functions against low frequency noise, converts the sound energy to heat energy and displays the noise absorption function. In addition, the lower face of the foam latex layer displays a waterproof nature without losing the cushion of the foam latex layer. If the waterproof thin film is finished with a texture pattern, the floor mat is stabilized wherever it is laid because the floor mat resists slipping (displays slip prevention function).

Because the felt layer and the foam latex layer are formed as a double layer as a backing material to the floor mat, the double layer displays two-types of absorption functions: a porous type sound absorption and a film vibration type sound absorption. This is especially true when the floor mat is laid on the primary carpet of the automobile, wherein noises such as road noise, engine noise, and wind noise to name but a few are effectively absorbed or interrupted and the quietness in the automobile room is improved.

Polypropylene cloth is preferably used as the backing cloth (3) and BCF nylon yarn is used for the pile layer (2). The nylon yarn is tufted by hand from the lower face (8) of the backing cloth (3) and forms the pile layer (2) on the upper face (7) of the backing cloth (3). In order to stabilize the pile layer (2), a styrene butadiene rubber group latex compound is spread on lower face (8) of the backing cloth (3) and allowed to dry.

The rate of sound absorption can be classified by 2 types of measurement methods. The first type is the reverberation room method sound absorption rate. The second type is the vertical irradiation sound absorption rate. The vertical irradiation method is used in the event the reverberation room method cannot be employed due to equipment requirements such as a reverberation room and a large quantity of test pieces.

In the vertical irradiation method, a test piece for sound absorption measurement is fixed at an end of a sound pipe and a speaker acts as a noise source. Sine wave of regulated frequency number is sent from the speaker, where the microphone is moved to obtain the sound absorption rate from the sound pressure level difference and sound pressure ratio at the maximum and the minimum of sound pressure occurred in the pipe.

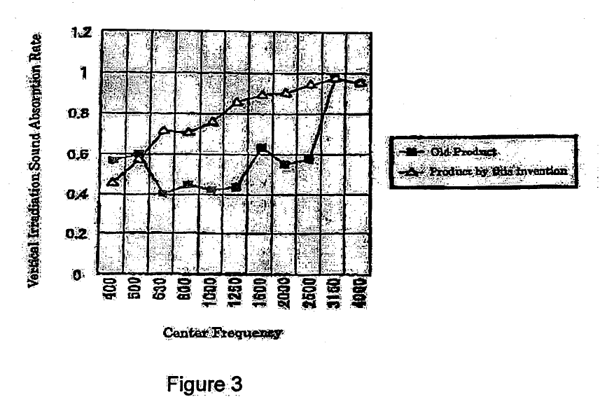

Measurements were taken on test pieces of both the present invention and the traditional floor mat, wherein the test pieces measured 99 mm and 29 mm. The 99 mm and the 29 mm pieces were used for the frequencies 100-1600 Hz and 800-5000 Hz, respectively. FIG. 3 shows a significant difference in sound absorption rate at the frequency belt zone of about 550 Hz to 3000 Hz of center frequency.

What is claimed is:

1. An automobile mat comprising:
a) a backing cloth having an upper and lower face;
b) a pile layer formed on said upper face of the backing cloth;
c) a felt layer adhered to the lower face of the backing cloth and a top face of a foam latex layer; and
d) the foam latex layer having the top and a bottom face adhered to a bottom face of the felt layer.

2. The automobile mat of claim 1, further comprising:
a plurality of holes passing through the felt layer and the backing cloth.

3. The automobile mat of claim 1, further comprising:
a waterproof film formed on the bottom face of the foam latex layer.

4. The automobile mat of claim 2, wherein the holes are sized 2 mm in diameter and spaced apart a distance of 5 mm from each other.

5. The automobile mat of claim 3, wherein the waterproof film further comprises a texture pattern.

6. The automobile mat of claim 1, wherein the pile layer is a BCF nylon yarn.

7. The automobile mat of claim 1, wherein the felt layer is a polyester hollow fiber felt.

8. The automobile mat of claim 1, wherein the backing cloth is a polypropylene cloth.

9. The automobile mat of claim 1, wherein the foam latex layer is a natural rubber group foam latex sheet which has foamed by 4 times.

10. The automobile mat of claim 1, wherein the pile layer is tufted from the lower face of the backing cloth.

11. The automobile mat of claim 1, wherein the pile layer is stabilized on the backing cloth with a styrene butadiene compound on the lower face of the backing cloth.

12. The automobile mat of claim 2, wherein each hole in the felt layer is aligned with each hole in the backing cloth.

13. The automobile mat of claim 1, wherein the felt layer is adhered to the foam latex layer by a chloroprene adhesive.

14. A process for producing the automobile mat of claim 1, wherein the felt layer is adhered to the backing cloth by applying a first and second layer of a chloroprene adhesive to the lower face of the backing cloth, wherein the first layer of the adhesive forms an adhesive film, and wherein the second layer of the chloroprene is applied to the adhesive film.
